(19) United States
(12) Patent Application Publication
(10) Pub. No.: US 2006/0162287 A1
(43) Pub. Date: Jul. 27, 2006

(54) Anisotropic conductive sheet

(76) Inventor: Miki Hasegawa, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/547,001

(22) PCT Filed: Feb. 27, 2004
(86) PCT No.: PCT/JP04/02355

§ 371 Date: Feb. 8, 2006

(30) Foreign Application Priority Data
Feb. 28, 2003 (JP) 2003-054779

(51) Int. Cl. B67B 3/10

(52) U.S. Cl. 53/362

(57) ABSTRACT

An anisotropic conductive sheet for high frequencies is provided as elastomer for connecting high-integrated circuit boards and fine pitch electronic components of recent years. Anisotropic conductive sheet (30) has a sheet-shaped elastomer (1c), and a non-conductive rectangular first penetrating region (11) is formed vertically and horizontally in a state surrounded by the sheet-shaped elastomer (1c). In addition, an electrically-conductive second penetrating region (12) is formed in a rectangular manner in a state surrounded by the first penetrating region (11). The first penetrating region 11 can be a high-dielectric rectangular third penetrating region. The anisotropic conductive sheet (30) has an effect in that electrostatic shield is provided between connected electronic components.

### FIELD OF THE INVENTION

The present invention relates to an anisotropic conductive sheet disposed between circuit boards such as printed circuit boards and various circuit components.

### RELATED ART

In recent years, more and more electronic devices have reduced their sizes and widths and it has become dramatically desirable to implement a connection between small circuits or a connection between a small component and a small circuit. As examples of such connections, there may be solder joining or joining with anisotropic conductive adhesives. In another example, an anisotropic conductive elastomer sheet may be disposed between an electronic component and a circuit board for conduction of electricity therebetween.

An anisotropic conductive elastomer sheet may be referred to as an elastomer sheet that has conductivity in a certain direction only. Some anisotropic conductive elastomer sheets exhibit conductivity only in a direction of width, and others in the direction of width only when pressed in the direction of width.

If the anisotropic conductive elastomer sheet is employed, it is possible to implement a compact electronic connection without other means such as soldering, mechanical fitting and so on, and also possible to absorb mechanical impact and strain. Therefore, anisotropic conductive elastomer sheets are widely utilized in many application fields such as liquid crystal display, cellular phone, electronic computer, electronic digital clock, electronic camera, computer and the like.

The anisotropic conductive elastomer sheets are also widely used as electronic connectors for connecting a circuit apparatus such as a printed circuit board, and a leaderless chip carrier or a liquid crystal panel. An elastomer connector is a connector utilizing elastomer such as conductive rubber disposed between electrodes to obtain an electrical connection simply by pressing the electrodes. One of such types of elastomer connectors may include an anisotropic conductive elastomer sheet having properties of being insulative in a horizontal direction and conductive in a vertical direction.

In the testing of electrical connections of circuit apparatus such as printed circuit boards and semiconductor integrated circuits, a sheet of anisotropic conductive elastomer is interposed and makes an electrical connection between an electrode region to be tested which is formed on at least one surface of the circuit apparatus to be tested and an electrode region of the testing circuit board which is formed on at least one surface of the testing circuit board.

Conventionally, it is known that an anisotropic conductive block is firstly formed by integrating aligned metal wires by using insulator and the resultant block is then sliced in a direction perpendicular to the direction of the metal wire so as to make an anisotropic conductive elastomer sheet. (As an example, referring to Japanese Laid-Open Patent Publication No. 2000-340037)

The use of metal wire in the anisotropic conductive elastomer sheet, however, makes it difficult to shorten the distance between the wires, therefore it is not easy to surely obtain the fine pitch that is demanded for anisotropic conductivity in the highly integrated circuit boards and electrical components in recent years. Metal wires are susceptible to a compressive buckling and may be dropped off from the sheet when used repeatedly such that the anisotropic sheet may not fully conduct performance thereof.

Although inductance and capacitance due to wiring patterns are minimal, these could become more serious for high-frequency applications and cause noise generation. When high-frequency electric current flows through the wiring patterns, emission of electro-magnetic waves and skin effect may arise and the noise generation may be caused. In particular, the clock frequency may reach 10 GHz with some devices such as hybrid IC and micro-wave IC.

In order to avoid such situations, twisted pair wire or a coaxial cable which can be shielded electromagnetically by appropriately grounding the cable shield with external conductor is employed in order to minimize mutual inductance with the electrical wire. In a pattern wiring on a printed board, strip lines may be formed to keep the impedance constant.

However, in elastomer connectors, the above described may not be applied such that it is desirable to obtain an elastomer connector which hardly causes noise generation and the like in high-frequency applications.

### SUMMARY OF THE INVENTION

From the above, it is an object of the present invention to provide an anisotropic conductive sheet for high-frequency applications such as an elastomer connector for connecting a recent integrated circuit board and a fine-pitch electronic component. More specifically, it is an object of the present invention to provide an anisotropic conductive sheet being characterized by fine-pitch anisotropic conductivity and electromagnetic wave shielding property, wherein such anisotropic properties are maintained even after repeated use.

It is advantageous that noise from junctions between electronic components can be prevented by connecting electronic components such as printed boards, cables and devices which transmit high-frequency signals as well as by ensuring the shield electromagnetic waves property in the elastomer connector. It is also possible to obtain high-admittance if dielectric material provided between signal lines.

It is also possible to improve the measurement performance by ensuring the shield electro-magnetic waves property in the elastomer connector in the electrical examination on the circuit devices such as printed circuit boards and semiconductor integrated circuits.

More specifically, the following is provided according to the present invention.

(1) An anisotropic conductive sheet being electrically conductive in only one direction, comprising: electrically-conductive sheet-shaped elastomer; at least one non-conductive first penetrating region being formed as being surrounded by the sheet-shaped elastomer; and an electrically-conductive second penetrating region being formed as being surrounded by the non-conductive first penetrating region.

(2) The anisotropic conductive sheet according to (1), wherein the second penetrating region is interspersed in the sheet-shaped elastomer.

(3) The anisotropic conductive sheet according to (1) or (2), wherein the second penetrating region is aligned with regularity in the sheet-shaped elastomer.

(4) The anisotropic conductive sheet according to any one of (1) to (3), wherein the second penetrating region has higher conductivity than the sheet-shaped elastomer.

(5) The anisotropic conductive sheet according to any one of (1) to (4), wherein the first penetrating region and the second penetrating region are formed in a concentric manner.

(6) The anisotropic conductive sheet according to any one of (1) to (4), wherein the first penetrating region and the second penetrating region are formed in a rectangular manner, and the rectangular first penetrating region and the rectangular second penetrating region are positioned with a same center of gravity.

(7) An anisotropic conductive sheet being electrically conductive in only one direction, wherein: the anisotropic conductive sheet has an electrically-conductive sheet-shaped elastomer; at least one high-dielectric third penetrating region is formed as being surrounded by the sheet-shaped elastomer; and an electrically-conductive second penetrating region is formed as being surrounded by the third penetrating region.

(8) The anisotropic conductive sheet according to claim 7, wherein the second penetrating region is interspersed in the sheet-shaped elastomer.

(9) The anisotropic conductive sheet according to (7) or (8), wherein the second penetrating region is aligned with regularity in the sheet-shaped elastomer.

(10) The anisotropic conductive sheet according to any one of (7) to (9), wherein the second penetrating region has higher conductivity than the sheet-shaped elastomer.

(11) The anisotropic conductive sheet according to any one of (7) to (10), wherein the third penetrating region and the second penetrating region are formed in a concentric manner.

(12) The anisotropic conductive sheet according to any one of (7) to (10), wherein the third penetrating region and the second penetrating region are formed in a rectangular manner, and the rectangular third penetrating region and the rectangular second penetrating region are placed with a same center of gravity.

(13) The anisotropic conductive sheet according to any one of (7) to (12), wherein the third penetrating region comprises ferroelectric substance.

(14) A pair of electronic components which are connected with the anisotropic conductive sheet according to any one of (1) to (13).

According to the present invention, there is provided an anisotropic conductive sheet which is electrically conductive in only one direction, wherein at least one non-conductive first penetrating region is formed within the sheet-shaped elastomer which is electrically conductive in only one direction such as to be surrounded thereby, and the second penetrating region which is electrically conductive in only one direction is formed within the non-conductive first penetrating region such as to be surrounded thereby.

The term “anisotropic conductive sheet” may be a flexible anisotropic conductive sheet which has a predetermined thickness, as well as a predetermined front surface and a predetermined back surface in front and back, or on up and down of the thickness. It may be an ordinary feature to have “a predetermined thickness, as well as a predetermined front surface and a predetermined back surface in front and behind, or on up and down of this thickness.” In other words, this anisotropic conductive sheet has a certain thickness and has a front surface and a back surface in the direction perpendicular to the thickness direction. That the sheet is “flexible” may mean that the sheet can be bent elastically.

“Electrically-conductive sheet-shaped elastomer” can be considered to be a sheet-shaped elastomer having electrical conductivity and can be sufficiently high conductivity. It also can be sufficiently low electrical resistance. The sheet-shaped elastomer is the main body of the anisotropic conductive sheet according to the present invention and has at least one hole piercing the sheet in the section wherein the penetrating regions, described hereafter, are formed. Non-conductive first penetrating region or third penetrating region is formed in this hole section. Therefore, the conduction direction of the anisotropic conductive sheet, as a whole, is only a certain direction (namely, if the drawing direction of the anisotropic conductive sheet is horizontal, vertical direction perpendicular thereto). The anisotropic conductive sheet according to the present invention, having an electrically-conductive sheet-shaped elastomer, has sufficient conductivity in the conduction direction.

Being non-conductive may mean that conductivity is sufficiently low and may mean that electrical resistance is sufficiently high. Because non-conductive first or third penetrating region is formed within the electrically-conductive sheet-shaped elastomer in the anisotropic conductive sheet of the present invention, the anisotropic conductive sheet, as a whole, comprises non-conduction direction which is not conductive. Because the anisotropic conductive sheet according to the present invention has a non-conductive penetrating region which is surrounded by the sheet-shaped elastomer, it has sufficient non-conductivity in the non-conduction direction of the anisotropic conductive sheet.

“Electrically-conductive elastomer” is referred to as elastomer which is electrically conductive and can generally be elastomer to which electrically-conductive material is combined to lower volume resistivity (for example, 1 Ωcm or below). More particularly, it can be elastomer which is obtained by combining electrically-conductive material to non-conductive elastomer material. Natural rubber, polyisoprene rubber, butadiene copolymers such as butadiene-styrene, butadiene-acrylonitrile, and butadiene-isobutylene, conjugated diene rubber, and hydrogen additives thereof are used as non-conductive elastomer materials. In addition, block copolymer such as styrene-butadiene-diene block copolymer rubber and styrene-isoprene block copolymer, the hydrogen additives thereof, chloroprene polymer, vinyl chloride-vinyl acetate copolymer, polyurethane rubber, polyester rubber, epichlorohydrin rubber, ethylene-propylene copolymer rubber, ethylene-propylene-diene copolymer rubber, soft liquid-form epoxy rubber, silicone rubber, fluorocarbon rubber or the like are also used as non-conductive elastomer materials.

Out of these, silicone rubber, which is superior in heat-resistance, cold-resistance, chemical-resistance, weather-resistance, electrical insulation and safety property, is preferably used. Electrically-conductive elastomer can be obtained by combining electrically-conductive materials such as pure metal, metal alloy, non-metallic powder (flakes, chips, foil, etc, as well) to such non-conductive elastomer material. Gold, silver, copper, nickel, tungsten, platinum, palladium and the like are given as examples of the pure metals. As the other metals, stainless steel (SUS), phosphor bronze, beryllium copper and the like are given. The non-metallic powder may include carbon and the like, and the carbon powder may include carbon nanotube, fullerene, etc.

“Electrically-conductive second penetrating region” can indicate one conductive thin-layer (called “metal layer” if composed of metal) formed within the non-conductive first penetrating region or high-dielectric third penetrating region such as to occupy a given area. If this is a metal layer, this can include instances wherein the entire metal layer is composed of one type of metal. In addition, the second penetrating region can have a function for electrically connecting the front surface side and the back surface side of the anisotropic conductive sheet.

The penetrating region can be considered to be formed such that the front surface and back surface of the anisotropic conductive sheet have a predetermined area, have thickness (namely, penetrates from the front surface of the anisotropic conductive sheet to the back surface), and have volume as materiality. In addition, the same of the penetrating region can be any shape in the front surface or the back surface of the sheet-shaped elastomer (or in the vicinity thereof). The shape of the penetrating region expressed on the front surface or back surface of the sheet-shaped elastomer can, for example, be circular or rectangular.

“Sheet-shaped” refers to a commonly conceived sheet-shaped flat plate and can be a circular plate or a rectangular plate. However, it is preferable that the plate thickness of the sheet-shaped elastomer is thin and as even as possible.

As non-conductive elastomer which is not electrically conductive is referred to and elastomer not including electrically-conductive materials may be referred to.

That a “first penetrating region is formed within the sheet-shaped elastomer such that the region is surrounded by the elastomer” can mean that the outer edge of the first penetrating region is surrounded by the sheet-shaped elastomer. Similarly, that a “second penetrating region is formed within the first penetrating region such that the second penetrating region is surrounded by the first penetrating region” can mean that the outer edge of the second penetrating region is surrounded by the first penetrating region, and the outer edge of the second penetrating region is not in direct contact with the sheet-shaped elastomer. Furthermore, the analogy can be applied by replacing the first penetrating region with the third penetrating region.

In the present invention, high-dielectric third penetrating region is formed in at least one location in the electrically-conductive sheet-shaped elastomer, and the electrically-conductive second penetrating region is formed in the high-dielectric third penetrating region.

The “dielectric”, stated herein, can be referred to as the relative permittivity. This permittivity differs according to the property of the third penetrating region. The high-dielectric third penetrating region can be considered to have a higher permittivity than the permittivity of the non-conductive first penetrating region.

The high-dielectric third penetrating region, therefore, can be composed of material having high permittivity. The material having high permittivity may, for example, include Ferroelectric substance.

Perovskite oxides such as barium titanate (BaTiO₃), lead titanate (PbTiO₃), lithium niobate (LiNbO₃), lithium tantalate (LiTaO₃) and the like are given as examples of “ferroelectric substances”. The third penetrating region can include chips, particles, flakes or powders formed from these materials.

Further, in the present invention, the electrically-conductive second penetrating region is interspersed in the electrically-conductive sheet-shaped elastomer while being surrounded by the first or third penetrating region.

That “the second penetrating region is interspersed” does not necessarily mean that the second penetrating region is interspersed randomly. In other words, the second penetrating region can be placed in the sheet-shaped elastomer either regularly or randomly. If there are a plurality of second penetrating regions, these second penetrating regions are dispersed in the sheet-shaped elastomer and aligned appropriately. Further, in correspondence to the placement of the second penetrating regions, the first or third penetrating region is also dispersed in the sheet-shaped elastomer and aligned appropriately. In other words, if a plurality of penetrating regions of the same type are provided in the same sheet-shaped elastomer in a plurality of locations, respectively, the adjacent penetrating regions of the same type do not share regions with each other (first penetrating regions with each other, second penetrating regions with each other, or third penetrating regions with each other).

Furthermore, in the present invention, the electrically-conductive second penetrating region is aligned with regularity in the electrically-conductive sheet-shaped elastomer.

Although to be “aligned with regularity” shows an appropriate placement pattern, more specifically, it may be considered to align the circular or rectangular second penetrating regions in a grid pattern in the anisotropic conductive sheet. The grid-shape in this case can be rectangular or rhombic. Further, the circular or rectangular second penetrating regions can be aligned, evenly spaced, in one row. Furthermore, preferably, the second penetrating region can be aligned in a matrix.

With regards to the alignment pitch of the second penetrating region, 1/10 inch- or, in other words, 2.54 mm-interval alignment can be considered if adjusting it to the land pattern placement of the printed board.

Further, the alignment pitch of the second penetrating region is, for example, preferably approximately 70 micrometers or smaller if adjusting it to fine pitch wherein the alignment pitch of the pad on the IC chip, the inner lead, or the outer lead is constricted.

Furthermore, in the present invention, the electrically-conductive second penetrating region has higher conductivity than the electrically-conductive sheet-shaped elastomer.

Here, the resistance between ordinarily connected ports of the electrically-conductive elastomer can be 100 to 1000Ω, and the resistance between ordinarily connected ports of the electrically-conductive second penetrating region is preferably 30Ω or lower. The electrically-conductive elastomer can include elastomer which is electrically conductive per se, elastomer which becomes electrically conductive by pressure-welding, and anisotropic conductive elastomer which is electrically conductive in only one direction. Electrically-conductive sheet-shaped elastomer can be, for example, elastomer obtained by combining electrically-conductive materials such as graphite with non-conductive elastomer material and forming into sheet-shaped. The electrically-conductive second penetrating region can, for example, be elastomer obtained from combining quality electrically-conductive materials such as gold and silver to non-conductive elastomer material and can be one conductive thin-layer (a metal layer if composed of metal).

Then, the selection of these conductive materials or the volume resistivity value of the electrically-conductive second penetrating region according to the combination ratio of the conductive materials to the non-conductive elastomer material can be set accordingly.

Furthermore, in the present invention, the non-conductive first penetrating region and the electrically-conductive second penetrating regions are formed in a concentric manner.

The electrically-conductive second penetrating region, the electrically-conductive sheet-shaped elastomer, and the non-conductive first penetrating elastomer of such anisotropic conductive sheet respectively correspond to the internal conductor composed of stranded wire (core wire), the outer conductor composed of braiding formed from thin conductive wire, and non-conductor as a spacer between the internal conductor and the outer conductor, and attempts to ensure the electromagnetic wave shielding property in the elastomer connector in the junctions between electronic parts.

In addition, the non-conductive first penetrating region is formed in a rectangular manner, the electrically-conductive second penetrating region is formed in a rectangular manner, the rectangular first penetrating region and the rectangular second penetrating region is positioned with the same center of gravity, and the present invention attempts to ensure the electro-magnetic wave shielding property in the elastomer connector in the junctions between electronic parts, as in the foregoing.

These non-conductive first penetrating region and electrically-conductive second penetrating region can be formed as an integrated component. The coupling agent for coupling these conductive elastomers and non-conductive elastomers is a bonding agent for coupling these components and can include common commercially-available adhesive agent. More specifically, it can be a coupling agent such as silane, aluminum, and titanate, and silane coupling agent is preferably used.

Furthermore, in the present invention, the high-dielectric third penetrating region and the electrically-conductive second penetrating region are formed in a concentric manner.

The electrically-conductive second penetrating region, the electrically-conductive sheet-shaped elastomer, and the high-dielectric third penetrating elastomer of such anisotropic conductive sheet respectively correspond to the internal conductor composed of stranded wire (core wire), the outer conductor composed of braiding formed from thin conductive wire, and dielectric material as a spacer between the internal conductor and the outer conductor, and is such that makes the elastomer connector in the junctions between electronic parts high-admittance and ensures the ability thereof to shield electro-magnetic waves.

In addition, the high-dielectric third penetrating region is formed in a rectangular manner, the electrically-conductive second penetrating region is formed in a rectangular manner, the rectangular third penetrating region and the rectangular second penetrating region is positioned with the same center of gravity, and the present invention makes the elastomer connector in the junctions between electronic parts high-admittance and ensures the ability thereof to shield electro-magnetic waves.

As an application example of the present invention, the anisotropic conductive sheet is connected to a pair of electronic components. A pair of electronic components is one pair of electronic components and refers to a component for sandwiching the anisotropic conductive sheet between this pair of electronic components. A printed board or an electrical component of fine pitch (for example, a semiconductor integrated circuit) are examples of such electronic components. The paired electronic components can be the same type of electronic component or can be a pair of differing electronic components such as a printed board and a semiconductor integrated circuit.

### BRIEF DESCRIPTION OF THE DRAWINGS

FIG. 1A is a perspective view of an anisotropic conductive sheet according to a first embodiment of the present invention.

FIG. 1B is a perspective view of an anisotropic conductive sheet according to a second embodiment of the present invention,

FIG. 2A is a perspective view of an anisotropic conductive sheet according the present invention wherein a plurality of rectangular penetrating regions is formed.

FIG. 2B is a perspective view of an anisotropic conductive sheet according the present invention wherein a plurality of circular penetrating regions is formed;

FIG. 3 is a perspective view for showing the manufacturing process of the anisotropic conductive sheet in FIG. 2A.

FIG. 4A is a perspective view for showing the manufacturing process subsequent to FIG. 3.

FIG. 4B is a perspective view for showing the manufacturing process subsequent to FIG. 4A.

FIG. 5 is a perspective view for showing the manufacturing method of the anisotropic conductive sheet in FIG. 2B.

FIG. 6A is a perspective view for showing the manufacturing process subsequent to FIG. 5.

FIG. 6B is a perspective view for showing the manufacturing process subsequent to FIG. 6A,

FIG. 7 is a perspective view showing an anisotropic conductive sheet according to an embodiment wherein a metallic metal layer is used as the second penetrating region of the present invention.

FIG. 8 is a partially enlarged view enlarging the upper left corner of the anisotropic conductive sheet in FIG. 7.

FIG. 9 is a diagram for showing the manufacturing process of the anisotropic conductive sheet in FIG. 7.

FIG. 10 shows an aspect wherein a laminated body is formed by layering a plate composed of non-conductive material attached with metal and a non-conductive bridge-shaped component, with regards to the manufacturing process of the anisotropic conductive sheet in FIG. 7.

FIG. 11 is a diagram wherein a laminated body is formed by further layering a plate composed of electrically-conductive material on the laminated body in FIG. 10.

FIG. 12 shows a state wherein a plurality of laminated bodies formed in the process in FIG. 11 is aligned.

FIG. 13 shows an aspect wherein a block is formed by further sandwiching a conductive sheet component between the laminated bodies in FIG. 12 and a process for cutting the laminated bodies.

### DESCRIPTION OF THE PREFERRED EMBODIMENT

Although the embodiments of the present invention are described hereafter, with reference to the drawings, the present invention is not limited to the present embodiments since the present embodiments show concrete materials and numerical values as preferred examples. Hereafter, like elements are designated to like numerical references and explanations thereof are omitted or simplified.

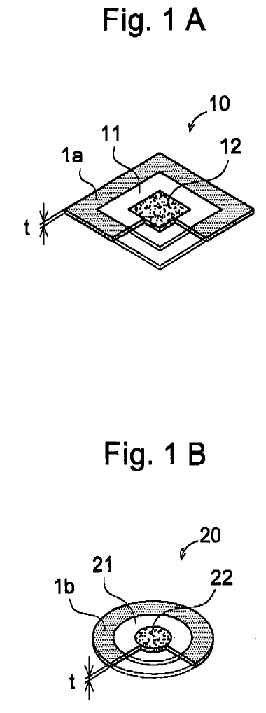

FIG. 1A is an appearance diagram of a rectangular anisotropic conductive sheet according to a first embodiment of the present invention, and FIG. 1B is that of a circular anisotropic conductive sheet according to a second embodiment of the present invention. Anisotropic conductive sheets 10 and 20 are sheet-shaped and respectively comprise electrically-conductive sheet-shaped elastomer 1a and 1b. A non-conductive first penetrating region 11 is formed in the anisotropic conductive sheet 10 such as to be surrounded by the sheet-shaped elastomer 1a. Similarly, a non-conductive first penetrating region 21 is formed in the anisotropic conductive sheet 20 such as to be surrounded by the sheet-shaped elastomer 1b.

Furthermore, an electrically-conductive second penetrating region 12 is formed in the anisotropic conductive sheet 10 being surrounded by the first penetrating region 11, and an electrically-conductive second penetrating region 22 is formed in the anisotropic conductive sheet 20 being surrounded by the first penetrating region 21, as well.

The sheet-shaped elastomer 1a, first penetrating region 11, and second penetrating region 12, which constitutes the anisotropic conductive sheet 10, are all formed in a rectangular manner. On the other hand, the sheet-shaped elastomer 1b, first penetrating region 21, and second penetrating region 22, which constitutes the anisotropic conductive sheet 20 in FIG. 1B, are all formed in a circular shape. The sheet-shaped elastomer 1a, first penetrating region 11, and second penetrating region 12 are positioned such that the center points overlap or, in other words, with the same center of gravity, and the sheet-shaped elastomer 1b, first penetrating region 21, and second penetrating region 22 are positioned in a concentric manner.

Although an example that the first and second penetrating regions are circular or rectangular is shown in the first and second embodiments, the shape of the first and second penetrating regions can be different as desired. It can, for example, be a polygon, an ellipse, and other shapes such as a closed curved surface.

In the first and second embodiments, the non-conductive first penetrating region 11 and 21 can be replaced with a high-dielectric third penetrating region. In this case, the third penetrating region may be formed from dielectric sheet wherein sheet-shaped elastomer comprises particles of high-dielectric ferroelectric substance. In particular, it can be formed by using material wherein barium titanate (BaTlO₃) is mixed with silicone rubber. The third penetrating region has the same shape as the first penetrating region 11 and 21, and is not illustrated.

In the first and second embodiments, the sheet-shaped elastomer 1a and 1b are formed from components wherein electrically-conductive particles are combined with silicone rubber. In particular, material wherein fine particles of carbon allotrope such as graphite are mixed with silicone rubber is used as conductive particles. The first penetrating region 11 and 21 are formed from non-conductive material being composed of silicone rubber. In addition, the second penetrating region 12 and 22 are electrically-conductive material wherein fine particles of silver (Ag) are mixed with silicone rubber as conductive metallic particles.

One example of manufacturing methods of the foregoing anisotropic conductive sheet 10 and 20 is as follows. Mold cavity corresponding to the shape of the first penetrating region 11 or 21 is punched out from the sheet-shaped elastomer 1a or 1b, and the first penetrating region 11 or 21, formed from non-conductive component, is fitted into this mold cavity. Then, the first penetrating region 11 or 21, as molding component, is coupled respectively with the sheet-shaped elastomer 1a or 1b with coupling agent.

Mold cavity corresponding to the shape of the second penetrating region 12 or 22 is punched out from the first penetrating region 11 or 21, beforehand, and the second penetrating region 12 or 22, formed from conductive component, is fitted into this mold cavity. Then, the second penetrating region 12 or 22, as molding component, is coupled respectively with the first penetrating region 11 or 21 with coupling agent.

Here, the sheet-shaped elastomer 1a, the first penetrating region 11 and the second penetrating region 12 have the same thickness. Similarly, the sheet-shaped elastomer 1b, the first penetrating region 21 and the second penetrating region 22 have the same thickness. By way of example, the thickness t in the drawing is about 0.5 to 1 mm.

Mitsubishi Plastics, Inc. product silicone rubber, Shin-Etsu Polymer Co., Ltd. product silicone rubber and the like are used as elastomer, and Shin-Etsu Polymer Co., Ltd. product silane coupling agent is used as a coupling agent.

It may be understood that the above anisotropic conductive sheet 10 or 20 comprises the non-conductive first penetrating region 11 or 21 being replaced with the insulating part of the conventional anisotropic conductive sheet-type elastomer connector, and the electrically-conductive second penetrating region 12 or 22 being replaced with the conductive part of the anisotropic conductive sheet-type elastomer connector.

However, though it is a main object of the anisotropic conductive sheet-type elastomer connector to simply connect electrically between electronic components, it is an object of the anisotropic conductive sheets 10 and 20 according to the present invention to connect between electronic components as the second penetrating regions 12 and 22 which are the signal transmitting parts is surrounded by the first penetrating regions 11 and 21 which are the insulating parts, and the first penetrating regions 11 and 21 are surrounded by the electrically-conductive sheet-shaped elastomer 1a and 1b which is the conducting part for grounding.

For example, if a printed board and a printed board are connected by a rectangular anisotropic conductive sheet 10, it is advantageous that the electro-magnetic wave shielding property is ensured in the Junction part between the printed boards and the generation of noise between the printed boards can be prevented.

Also, the non-conductive first penetrating regions 11 and 21 of the anisotropic conductive sheets 10 and 20 according to the present invention are replaced with a high-dielectric third penetrating region, as the second penetrating regions 12 and 22 are made signal transmitting parts and the third penetrating region, being formed to surround the second penetrating regions 12 and 22, is made a dielectric material, then the third penetrating region is further surrounded by the electrically-conductive sheet-shaped elastomer 1a and 1b, and the sheet-shaped elastomer 1a and 1b is made conducting parts for grounding.

If, for example, one coaxial cable and another coaxial cable are connected with a circular anisotropic conductive sheet in this configuration, the electro-magnetic wave shielding property is ensured in the Junction part of the coaxial cables such that the generation of noise from disconnection of the coaxial cables can be prevented so as to obtain high-admittance.

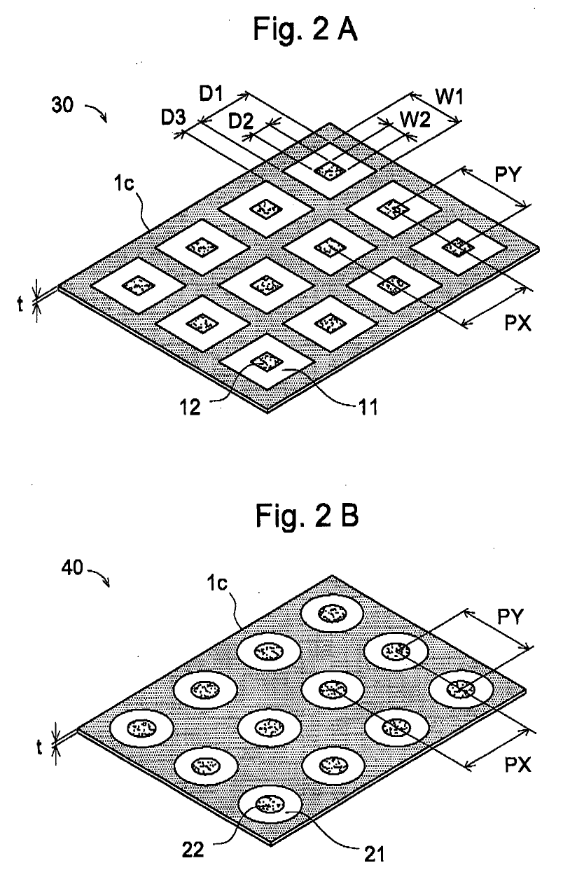

Next, the anisotropic conductive sheet forming a plurality of second penetrating regions is described using FIGS. 2A and 2B.

In the anisotropic conductive sheet 30 shown in FIG. 2A, a plurality of non-conductive rectangular first penetrating regions 11 are formed vertically and horizontally as being surrounded by electrically-conductive rectangular sheet-shaped elastomer 1c. Then, electrically-conductive second penetrating regions 12 are formed in a rectangular manner in a state of being surrounded by the first penetrating regions 11. The second penetrating region 12 is formed at one location for each first penetrating region 11, and the rectangular first penetrating region and the rectangular second penetrating region 12 are positioned with the same center of gravity. A rectangular high-dielectric third penetrating region being composed of high-dielectric material can be formed in place of the rectangular first penetrating region 11. The rectangular third penetrating region has the same shape as the first penetrating region 11 and is not illustrated.

In the anisotropic conductive sheet 40 shown in FIG. 2B, a plurality of non-conductive circular first penetrating regions 21 are formed vertically and horizontally as being surrounded by electrically-conductive rectangular sheet-shaped elastomer 1d. Then, electrically-conductive second penetrating regions 22 are formed in a circular shape in a state of being surrounded by the respective circular first penetrating regions 21. The second penetrating region 22 is formed one location for each first penetrating region 21, and the circular first penetrating region and the circular second penetrating region 22 are positioned in a concentric manner. The circular first penetrating region 21 can be replaced with a circular third penetrating region composed of high-dielectric material. Because the third penetrating region has the same shape as the first penetrating region, the anisotropic conductive sheet having the third penetrating region is not illustrated.

Although the second penetrating regions 12 and 22 are aligned with regularity in a matrix in the foregoing anisotropic conductive sheets 30 and 40, the second penetrating regions 12 and 22 can be placed scattered randomly as desired. In addition, the second penetrating regions 12 and 22 can be aligned, evenly spaced, in one row.

When using the anisotropic conductive sheet 30 shown in FIG. 2A to join fine pitch electronic components, the length D1 of the non-conductive first penetration region 11 (or third penetration region) is preferably 100 μm or shorter and the length D2 of the second penetrating region 12 is preferably 50 μm or shorter. In addition, the distance D3 between adjacent first penetrating regions 11 (or third penetrating regions) is preferably 30 μm or shorter. In such range, the alignment pitch distance PX between adjacent second penetrating regions 12 can be 130 μm or longer.

In the embodiment in FIG. 2A, width W1 of the non-conductive first penetrating region 11 (or third penetrating region) is approximately 80 μm, the alignment pitch distance PY to the adjacent first penetrating region 11 is approximately 130 μm, and the width W2 of the second penetrating region 12 is approximately 50 μm. However, it should be understood that width W1, W2 and distance PY can be longer (or larger) than this in other embodiments.

In the embodiment in FIG. 2B, if the alignment pitch PX and PY of the second penetrating region 22 is adjusted to the land pattern placement of a printed board, the second penetrating region 22 can be considered to be aligned in 1/10 inch- or, in other words, with 2.54 mm-intervals. It should be understood that the alignment pitch PX and PY of the second penetrating region 22 can be longer (or larger) or shorter (or smaller) than this in other embodiments.

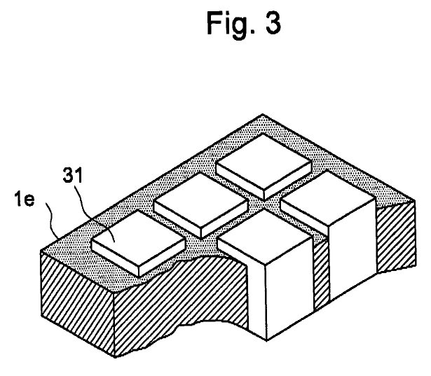

Next, the manufacturing method of the anisotropic conductive sheet 30 in FIG. 2A is described in reference to FIGS. 3, 4A and 48.

First, a plurality of quadrangular prism cores 31 are provided vertically and horizontally in a box-shaped cuboid frame (not illustrated). Then, compounded rubber prepared by kneading crude caoutchouc with electrically-conductive fine particles such as graphite and small amount of sulfur and additives is placed in this frame and molded. Furthermore, the compounded rubber is vulcanized by heating, and the conductive block 1e as shown in FIG. 3 is obtained.

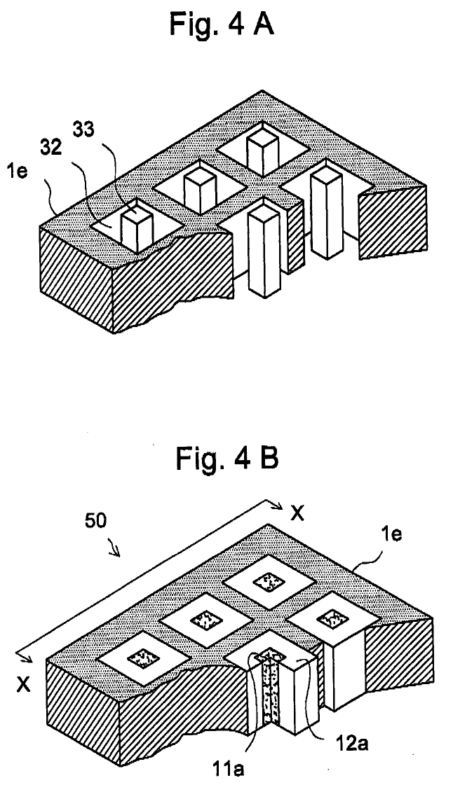

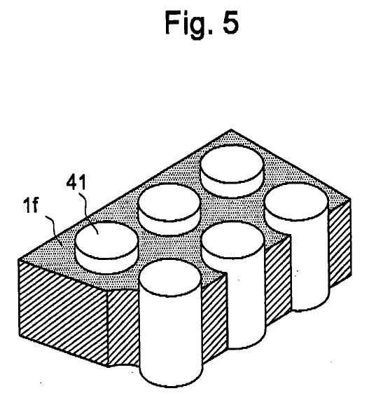

Next, as shown in FIG. 4A, a core 31 is removed from the conductive block 1e and second quadrangular prism core 33 is provided to stand within a rectangular penetration hole 32. Then, unvulcanized non-conductive rubber (or rubber having been kneaded with fine particles of ferroelectric substance such as barium titanate) is poured into the penetration hole 32, and unvulcanized non-conductive block 12a (or dielectric block) is formed. Then, the unvulcanized non-conductive block 12a (or dielectric block) and the vulcanized conductive block 1e are bonded by heating.

Next, the second core 33 is removed from the conductive block 1e and unvulcanized conductive rubber 11a having been kneaded with conductive material such as silver is poured into the second penetration hole from which the second core 33 had been removed. Then, the unvulcanized conductive rubber 11a and the vulcanized non-conductive block 12a (or dielectric block) are bonded by heating.

By cutting along an X-X cutting-plane line the anisotropic conductive block 50 shown in FIG. 4B, which is manufactured as described above, with the anisotropic conductive sheet 30 shown in FIG. 2A is obtained.

The anisotropic conductive block 50 can be cut with a blade, such as hard metal cutter, ceramic cutter and the like, by a grinding stone such as fine cutter, by a saw such as a saw, and by other cutting instruments and cutting devices (may include a non-contact cutting device such as a laser cutting machine).

Cutting fluid such as cutting oil can also be used in order to prevent overheating when cutting in order to obtain a clean cut surface, and for other purposes, and it also can be cut in a dry condition.

In this way, it is rather easy to make an anisotropic conductive sheet comprising thin sheet-shaped elastomer as a main body and an anisotropic conductive sheet comprising thick sheet-shaped elastomer as a main body, which used to be believed difficult. Although the thickness of sheet-shaped elastomer is generally about 1 mm, it can be about 100 μm or thinner (about 50 μm or thinner if particularly desired) when making it thinner and on the other hand it also can be several millimeters. The thickness of this example is about 1 mm.

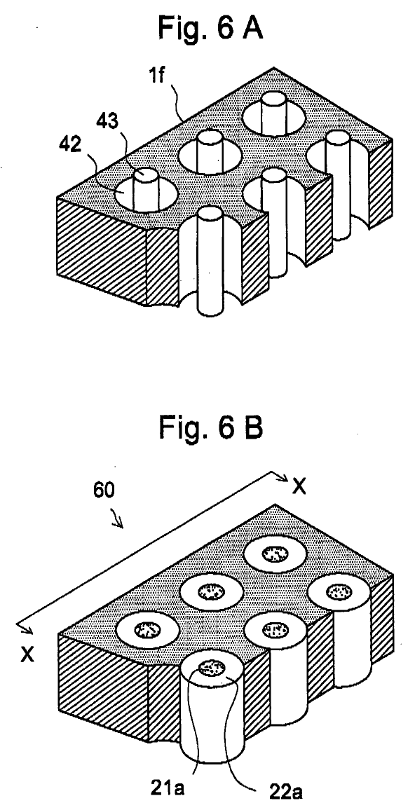

Next, the manufacturing method of the anisotropic conductive sheet in FIG. 2B is described in reference to FIGS. 5, 6A and 6B.

First, a plurality of cylindrical cores 41 are provided to stand vertically and horizontally in a box-shaped cuboid frame (not illustrated). Then, compounded rubber comprising crude rubber having been kneaded with electrically-conductive fine particles such as graphite and small amount of sulfur and additive is placed in this frame and molded. Furthermore, it is vulcanized by heating, and the conductive block 1f shown in FIG. 5 is obtained.

Next, as shown in FIG. 6A, cylindrical core 41 is removed from the conductive block 1f and second cylindrical core 43 is stuck within a circular penetration hole 42. Then, unvulcanized non-conductive rubber (or rubber having been kneaded with fine particles of ferroelectric substance such as barium titanate) is poured into the circular penetration hole 42, and unvulcanized non-conductive block 22a (or dielectric block) is formed. Then, the unvulcanized non-conductive block 22a (or dielectric block) and the vulcanized conductive block 1f are bonded by heating.

Next, the second cylindrical core 43 is removed from the conductive block 1f and unvulcanized conductive rubber 21a having been kneaded with conductive material such as silver is poured into the second circular penetration hole after removing the cylindrical second core 43. Then, the unvulcanized conductive rubber 21a and the vulcanized non-conductive block 22a (or dielectric block) are bonded by heating.

By cutting along an X-X cutting-plane line the anisotropic conductive block 60 shown in FIG. 6B which is manufactured as described above, the anisotropic conductive sheet 40 shown in FIG. 2B is obtained.

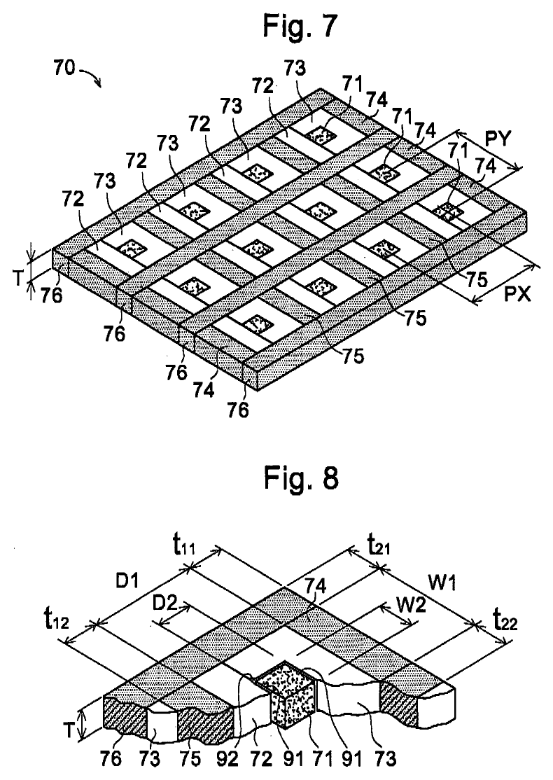

Next, other manufacturing methods for obtaining an anisotropic conductive sheet similar to the anisotropic conductive sheet 30 shown in FIG. 2A are described. FIG. 7 shows an anisotropic conductive sheet 70 which uses metallic metal layer as the second penetrating region.

Although the anisotropic conductive sheet 70 of the present embodiment is a rectangular sheet, it can also be applied to sheet-shaped components in a shape other than the rectangular. In the anisotropic conductive sheet 70, metallic metal layer 71 is sandwiched by a concave component 73 and a non-conductive strip-shaped component 72 being composed of non-conductive sub-components, which surround the metal layer 71. Furthermore, the non-conductive strip-shaped component 72 and the concave component 73 are configured so as to be sandwiched and surrounded by electrically-conductive strip-shaped components 74, 75, and 76, being composed of electrically-conductive components.

In this embodiment, the non-conductive strip-shaped component 72 and the concave component 73 form the rectangular first penetrating region, and the metal layer 71 forms the rectangular second penetrating region.

When forming the high-dielectric third penetrating region in place of the non-conductive first penetrating region in the anisotropic conductive sheet 70, non-conductive strip-shaped component 72 can be replaced with strip-shaped component formed from dielectric material. Similarly, non-conductive concave component 73 can be replaced with strip-shaped component formed from dielectric material.

The metallic metal layer 71, and the non-conductive strip-shaped component 72 and concave component 73 can be coupled, and in turn the components 72, 73 and conductive strip-shaped components 74 to 78 can be coupled by a coupling agent. For the anisotropic conductive sheet 70 of this embodiment, Mitsubishi Plastics, Inc. product silicone rubber, Shin-Etsu Polymer Co., Ltd. product silicone rubber and the like are employed as non-conductive elastomer, and Shin-Etsu Polymer Co., Ltd. product silane coupling agent is used as the coupling agent. The metallic metal layer 71 can include a metal layer of one type of metal and the metal layer 71 can comprise multi-layered conductive thin-layers.

FIG. 8 is a partially enlarged view enlarging the upper left corner of FIG. 7 and shows the non-conductive strip-shaped component 72 and concave component 73 in more detail. As shown in FIG. 8, non-conductive strip-shaped component 72 and concave component 73 are mutually coupled with the coupling agent via an adhesive layer 91.

When the metal layer 71, non-conductive strip-shaped component 72 and concave component 73 are not accurately aligned, space 92 is generated on both sides of metal layer 71. However, if the metal layer 71 is sufficiently thin, such spaces may not exist. These spaces can be left open simply as space or can be filled with coupling agent or other filler. Generally, if the spaces are left open, crack tip part of a sharp angle can easily progress as cracks and, as a result, the coupled non-conductive strip-shaped component 72 and concave component 73 may become separated. Therefore, it is preferable, from this perspective, to fill the spaces with filler.

In FIG. 8, the length of the second penetrating region formed in the metal layer 71 is D2 and the width is W2. The length and width of the first penetrating region formed in the non-conductive strip-shaped component 72 and concave component 73 are D1 and W1, respectively. Further, the width of conductive strip-shaped component 74 is t₁₁, the width of conductive strip-shaped component 75 is t₁₂, and the width of conductive strip-shaped component 76 is t₂₁ or t₂₂.

Although each of these measurements can be set arbitrarily, in the present embodiment, t₁₁=t₁₂ and t₂₁=t₂₂. Further, though the length D2 and width W2 of the second penetrating region formed in the metal layer 71 can also be set arbitrarily, length D2 can be set, for example, to about 50 μm.

Although the thickness, width and length of the anisotropic conductive sheet of the present embodiment is not limited, when using the anisotropic conductive sheet to connect between a circuit board and the terminal of an electronic component, it is preferable that it is of a size consistent with these measurements. In these cases, width and length are generally 0.5 to 3.0 cm×0.5 to 3.0 cm and thickness is 0.5 to 2.0 mm.

The thickness of these strip-shaped components is the same in this example, and therefore, the thickness of the sheet is the thickness shown by T in FIG. 8. As stated earlier, the adjacent non-conductive strip-shaped component 72 and concave component 73 are coupled by the coupling agent and then they constitute one sheet as shown in FIG. 7. Here, the coupling agent for coupling is non-conductive, and the non-conductivity in the surface direction of the sheet is ensured.

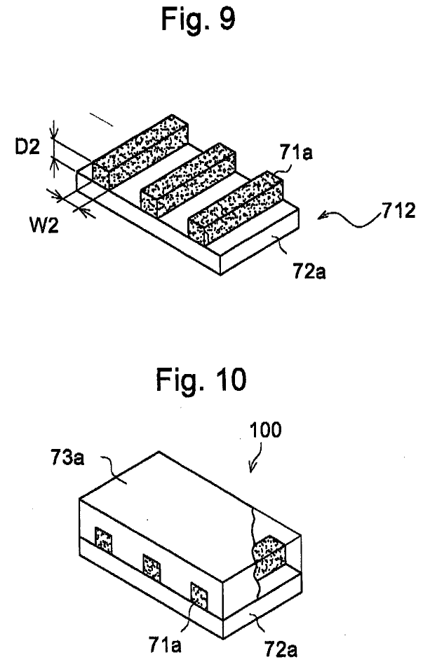

Next, a method for manufacturing the anisotropic conductive sheet 70 of the foregoing embodiment is described in reference to FIGS. 9 to 13. FIG. 9 shows a metallic metal rod 71a and a board with metal 712 formed from non-conductive board-shaped component 72a. The metal rod 71a becomes metal layer 71 in FIG. 7 and non-conductive board-shaped component 72a becomes a non-conductive strip-shaped component 72 in FIG. 7.

Though metal rods 71a in FIG. 9 can be prepared by a variety of methods, they are deposited in the form by sputtering in this embodiment. In other words, the non-conductive board-shaped component 72a is a substrate, target matching the components of the metal rod 71a to be formed is adjusted and metal rod 71a is attached by sputtering device. The width of each metal rod 71a and intervals thereof can be adjusted by performing appropriate masking. The non-conductive board-shaped component 72a of this embodiment is non-conductive elastomer, and therefore modifications should be made such that the substrate temperature does not rise excessively, for example, using magnetron sputtering, ion beam sputtering and the like.

FIG. 10 shows an aspect wherein a laminated body 100 is formed by layering a non-conductive bridge-shaped component 73a, which is the concave component 73 in FIG. 7, onto a board with metal 712. Laminated body 100 is formed by applying coupling agent between the board with metal 712 and non-conductive bridge-shaped component 73a and coupling both components.

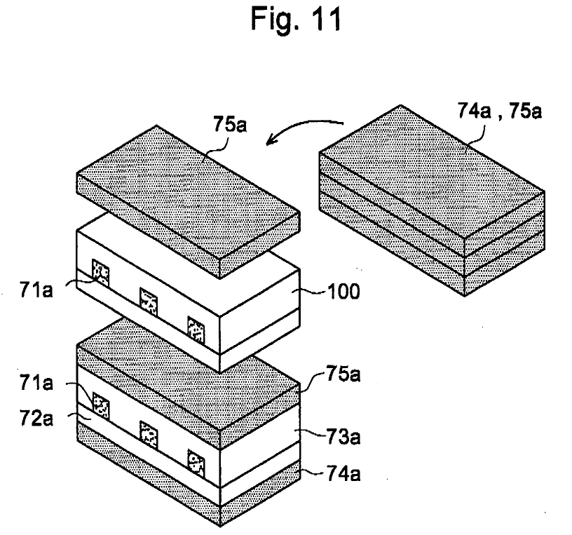

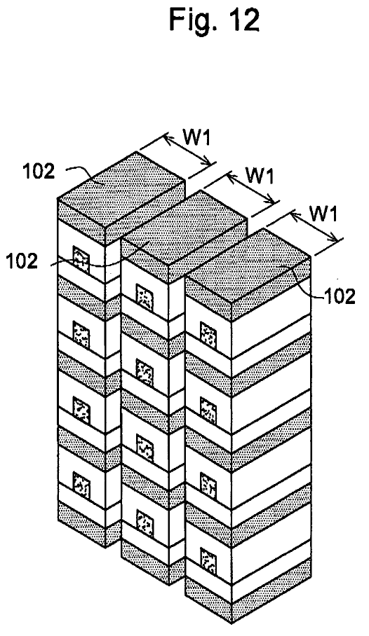

FIG. 11 shows an aspect wherein the laminated body 100 and conductive board 74a and 75a formed from electrically-conductive material are further layered. Conductive board 74a becomes the electrically-conductive strip-shaped component 74 of FIG. 7, and conductive board 75a becomes the electrically-conductive strip-shaped component 75 of FIG. 7. A plurality of laminated bodies 100 and conductive board 75a are layered such that metal rod 71a is aligned in parallel. The widths of laminated body 100 and conductive board 74a and 75a are the same, coupling agent is applied between the laminated body 100 and conductive board 74a and 75a, the laminated body 100 and conductive board 74a and 75a are coupled by coupling agent, and the laminated body 102 shown in FIG. 12 is formed.

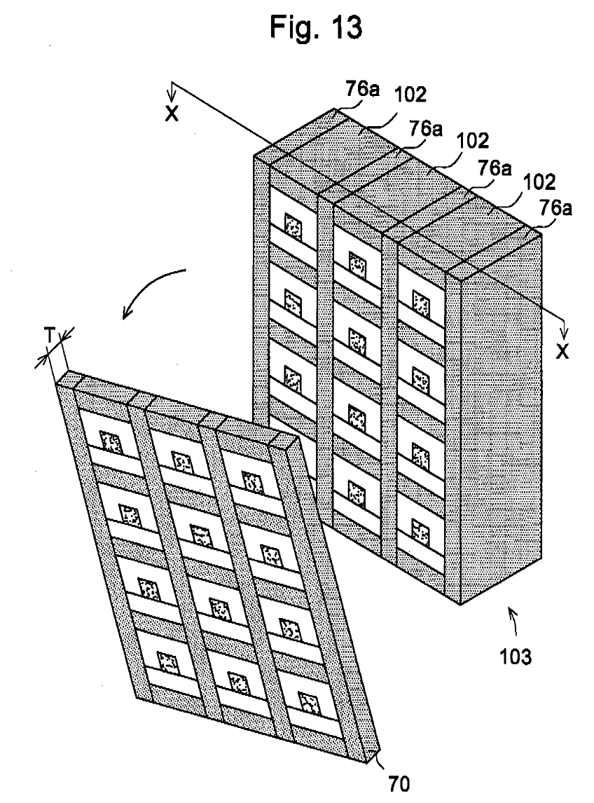

The laminated body 102 which has been formed by the foregoing process is cut such that the width of the first penetrating region (namely, the region formed by non-conductive strip-shaped component 72 and concave component 73) of the anisotropic conductive sheet shown in FIG. 13 may be desirable width W1. Then, a plurality of laminated bodies 102 which have been cut evenly to become width W1 is aligned as shown in FIG. 12.

FIG. 13 shows an aspect wherein laminated body 103 is formed by further sandwiching conductive sheet component 78a between a plurality of laminated bodies 102. The depth and height of conductive sheet component 76a is the same as the depth and height in the cut surface of laminated body 102, respectively, and conductive sheet components 76a are stacked such that directions of metal rods 71a are all uniform (such as to be parallel). The conductive sheet component 76a becomes the electrically-conductive strip-shaped component 78 in FIG. 7. The coupling agent is applied between these laminated bodies 102 and conductive sheet components 78a, laminated bodies 102 and conductive sheet components 76a are coupled with coupling agent, and block 103 is formed.

FIG. 13 shows the process for cutting block 103 which has been formed by the foregoing process. The block 103 is cut along the X-X line with an arbitrary thickness T, and an anisotropic conductive sheet 70 of thickness T is obtained. This thickness T is equivalent to T in FIG. 7, t in FIGS. 1A, 1B, 2A and 2B. Therefore, the conventionally difficult formation of thin anisotropic conductive sheets and the formation of thick anisotropic conductive sheets can be facilitated. Although the thickness is generally about 1 mm, it can be about 100 μm or thinner (about 50 μm or thinner if particularly desired) when making it thin and it can also be several millimeters. It is about 1 mm in this example.

The metallic metal layer 71 is, for example, copper (Cu). The copper can be plated with electrically-conductive coating beforehand, or the coating can be applied after anisotropic conductive sheet is completed. In addition, if the high-dielectric third penetrating region is formed in place of the non-conductive first penetrating region in anisotropic conductive sheet 70, strip-shaped component formed from dielectric material is formed in place of non-conductive strip-shaped component 72 and concave component formed from dielectric material can be formed in place of non-conductive concave component 73, respectively, by using dielectric sheet formed from dielectric material in place of the non-conductive board-shaped component 72a comprising board with metal 712 and dielectric bridge-shaped component formed from dielectric material in place of non-conductive bridge-shaped component 73a. In this case, strip-shaped component formed from dielectric component and concave component formed from dielectric component form the third penetrating region.

Because, in this way, the anisotropic conductive sheet surrounds the electrically-conductive second penetrating region with the non-conductive penetrating region and further surrounds the non-conductive first penetrating region with the conductive elastomer, while ensuring insulation and elasticity in the surface direction as elastomer connector, this is effective in that electrostatic shield is provided between the electronic components connected to this anisotropic conductive sheet. For example, it can be prevented that the shield is broken by providing this anisotropic conductive sheet to connection components between the coaxial cable and the circuit board.

Further, the areas and pitches of the non-conductive first penetrating region (or high-dielectric third penetrating region) and the electrically conductive second penetrating region can be set freely, and desired fine pitch can be easily attained by high-integration. Further, because the first penetrating region, second penetrating region and sheet-shaped elastomers are joined (rubber bridge) chemically, it is effective in reducing the threat of deficiency due to missing conductive parts and the like, which may occur when using linear metals as conductive parts.

In the anisotropic conductive sheet, because the electrically-conductive second penetrating region is surrounded by high-dielectric third penetrating region and the high-dielectric third penetrating region is further surrounded by conductive elastomer, low inductance between the connection of electronic components is possible by making the thickness of this anisotropic sheet about 0.5 mm to 2 mm. Furthermore, high-admittance due to ferroelectric substance can also be expected.

1. An anisotropic conductive sheet being electrically conductive in only one direction; comprising:
electrically-conductive sheet-shaped elastomer;
at least one non-conductive first penetrating region being formed as being surrounded by the sheet-shaped elastomer; and
an electrically-conductive second penetrating region being formed as being surrounded by the at least one non-conductive first penetrating region.

2. The anisotropic conductive sheet according to claim 1, wherein the second penetrating region is interspersed in the sheet-shaped elastomer.

3. The anisotropic conductive sheet according to claim 1, wherein the second penetrating region is aligned with regularity in the sheet-shaped elastomer.

4. The anisotropic conductive sheet according to claim 1, wherein the second penetrating region has higher conductivity than the sheet-shaped elastomer.

5. The anisotropic conductive sheet according to claim 1, wherein the first penetrating region and the second penetrating region are formed in a concentric manner.

6. The anisotropic conductive sheet according to claim 1, wherein the first penetrating region and the second penetrating region are formed in a rectangular manner, and the rectangular first penetrating region and the rectangular second penetrating region are positioned with a same center of gravity.

7. An anisotropic conductive sheet being electrically conductive in only one direction, wherein:
the anisotropic conductive sheet has an electrically-conductive sheet-shaped elastomer;
at least one high-dielectric third penetrating region is formed as being surrounded by the sheet-shaped elastomer; and
an electrically-conductive second penetrating region is formed as being surrounded by the third penetrating region.

8. The anisotropic conductive sheet according to claim 7, wherein the second penetrating region is interspersed in the sheet-shaped elastomer.

9. The anisotropic conductive sheet according to claim 7, wherein the second penetrating region is aligned with regularity in the sheet-shaped elastomer.

10. The anisotropic conductive sheet according to claim 7, wherein the second penetrating region has higher conductivity than the sheet-shaped elastomer.

11. The anisotropic conductive sheet according to claim 7, wherein the third penetrating region and the second penetrating region are formed in a concentric manner.

12. The anisotropic conductive sheet according to claim 7, wherein the third penetrating region and the second penetrating region are formed in rectangular, and the rectangular third penetrating region and the rectangular second penetrating region are placed with a same center of gravity.

13. The anisotropic conductive sheet according to claim 7, wherein the third penetrating region comprises ferro electric substance.

14. A pair of electronic components which are connected with the anisotropic conductive sheet according to claim 1.

15. A pair of electronic components which are connected with the anisotropic conductive sheet according to claim 7.
